(19) United States
(12) Patent Application Publication
(10) Pub. No.: US 2005/0048225 A1
(43) Pub. Date: Mar. 3, 2005

(54) Playground foundation formed of a composite layered surface

(76) Inventors: Charles D. Morris, Montgomery, IL (US); Garry Graham, Oswego, IL (US)

Correspondence Address: McAndrews, Held & Malloy, Ltd., 34th Floor, 500 W. Madison Street, Chicago, IL, 60661, US

(21) Appl. No.: 10/654,413

(22) Filed: Sep. 3, 2003

(51) Int. Cl. B32B 5/06; B32B 5/16

(52) U.S. Cl. 428/17; 428/327; 428/317.9

(57) ABSTRACT

The present invention provides an improved foundation for human recreation areas, such as playgrounds. The improved foundation preferably includes a foundation layer, a drainage layer, an impact dampening layer, a cover layer, and at least one fixed barrier. The cover layer is preferably composed of an artificial turf with granules of rubber dispersed throughout the turf. The impact dampening layer is preferably composed at least in part of rubber particles and provides for impact resistance for falls or other trauma. The cover layer is preferably positioned in top of the impact dampening layer and serves to contain the rubber particles of the impact dampening layer. The impact dampening ability of the impact dampening layer may preferably be increased by increasing the depth of the impact dampening layer. The surface may also be color coded, for example with regard to impact level.

### BACKGROUND OF THE INVENTION

The present invention generally relates to a foundation for playgrounds and recreation areas. More specifically, the present invention relates to a playground or recreation area foundation formed of composite layers.

Many potential hazards exist at playgrounds, including falls from the equipment to the ground surface below. In fact, most serious playground injuries result from these types of falls. Falls onto a impact dampening surface or foundation are less likely to cause serious injuries than falls onto a hard surface. The more impact dampening a surface can be made, the greater is the likelihood of preventing serious injuries. Thus, the impact dampening capability of the surface or foundation under and around playground equipment can be a major factor in determining the occurrence or extent of injuries due to a fall. The terms playground surface and playground foundation are often used interchangeably, although the term foundation is probably more properly applied as the playground surfacing material increases in thickness.

There is no precise method of predicting the threshold tolerance of the human anatomy, such as the human head, to an impact injury. However, experts in the field have established two methods that may be used to determine when such an injury may or may not be life threatening. The first method holds that if the peak deceleration of the head during impact does not exceed 200 times the acceleration due to gravity (200 G's), a life threatening head injury is not likely to occur. The second method holds that both the deceleration of the head during impact and the time duration over which the head decelerates to a halt are significant in assessing head impact injury. This latter method uses a mathematical formula to derive a value known as the Head Injury Criteria (HIC). Head impact injuries are not believed to be life threatening if the HIC does not exceed a value of 1,000.

The most common procedure for evaluating the impact dampening properties of a playground surfacing material is to drop an instrumented metal headform onto a sample of the material and record the acceleration/time pulse during the impact. The Critical Height (CH) of a surfacing material may be considered as an approximation of the fall height below which a life-threatening head injury would not be expected to occur, and is defined as defined as the maximum height from which the instrumented metal headform, upon impact, yields both a peak deceleration of no more than 200 G's and a HIC of not more than 1,000. Any surface for playgrounds must meet these requirements.

Consequently, hard surfacing materials, such as asphalt or concrete, are unsuitable for use under and around playground equipment, unless they are required as a base for another impact dampening material. Although an improvement over concrete, earth surfaces, such as soils and hard packed dirt are also not recommended because they have poor impact dampening properties. Similarly, grass and turf are not recommended because wear and environmental conditions can reduce their effectiveness in dampening impact during a fall.

According to the U.S. Consumer Product Safety Commission (“CPSC”), currently approved playground surfacing materials include unitary materials and loose-fill materials. Unitary materials are generally impact dampening mats such as rubber mats or a combination of impact dampening materials held in place by a binder that may be poured in place at the playground site and then cured to form a unitary impact dampening surface. Such surfaces or foundations are available from many different manufacturers and have a wide range of impact dampening properties. Unitary materials also include rubber or rubber over foam mats or tiles and poured in place urethane and rubber compositions. In general, unitary materials are low maintenance and retain their impact dampening properties. However, such materials typically have high initial and maintenance costs and are more difficult to install than loose-fill materials.

The second type of playground surfacing materials are loose-fill materials. Loose-fill materials may also have acceptable impact dampening properties when installed and maintained at a desired depth. Loose-fill materials include wood chips, bark mulch, sand, gravel, and shredded tires. In general, the advantages of loose-fill materials include lower installation and maintenance costs than unitary materials, as well as an easier installation than unitary materials.

However, loose-fill materials suffer from several disadvantages. For example, the depth of the loose-fill materials may be reduced due to displacement by children's activities, thereby reducing or altering the ability of the loose-fill material to reduce or dampen impacts. Additionally, environmental effects, such as rainy weather, high humidity, freezing temperatures, and wind may also ability of the loose-fill material to dampen impacts. Also, human motion, such as running or walking, may be more difficult on loose-fill materials than unitary materials. Further, loose-fill materials may be easily disturbed or thrown by children or may other wise harm children, for example, by being swallowed. Also, undesirable materials, such as sharp objects, trash, animal excrement, drugs, and weapons may be easily concealed in loose-fill materials. Finally, frequent maintenance may be necessary to insure adequate depth and to loosen the loose-fill materials which may have become packed, so that the ability of the loose-fill materials to dampen or minimize impacts is not impaired.

Some common loose-fill materials include sand, gravel, wood chips, bark mulch, and shredded rubber. Wood-based loose-fill materials such as wood chips and bark mulch are typically preferred over stone-based loose fill materials such as sand and gravel due to the greater impact dampening ability of the wood-based loose-fill materials.

As mentioned above, in addition to the wood and stone-based loose-fill materials, shredded or recycled rubber has occasionally been employed as a loose-fill material. Recycled rubber typically provides enhanced drainage as compared to other loose-fill materials, such as sand or gravel. However, employing shredded rubber as a loose-fill material yields the same drawbacks recited above for all loose-fill materials. The use of shredded rubber also yields some additional drawbacks. For example, shredded rubber loose-fill materials may soil clothing. Also, shredded rubber loose-fill materials may include undesirable materials because the shredded rubber is typically derived from used tires. Although the tires are typically cleaned thoroughly, materials embedded in the tires, such as roadway materials and wires from steel belted radials may undesirably be included in the shredded rubber.

Consequently, as discussed in the paragraphs above, loose-fill materials may be preferred over unitary materials because loose-fill materials are typically more affordable than unitary materials. However, as discussed above, among other concerns, the impact dampening capability of loose-fill materials may be undesirably inconsistent and may require continual maintenance. Additionally, although loose-fill materials are typically approved by the CPSC, such materials are not typically compliant with legislation such as the Americans with Disabilities Act (“ADA”). For example, loose-fill materials do not provide the firm surface for those individuals that require wheelchair access.

Additionally, improper use of currently approved playground materials, both unitary and loose-fill materials as discussed above, may occasionally give rise to other minor injuries, such as floor or turf burns, commonly associated with these materials when used in conjunction with human recreation areas, such as playgrounds.

Thus, a need has long been felt for an improved surface or foundation for human recreation areas such as playgrounds. A need has especially been felt for such a surface that has reliable impact dampening properties. Additionally, a need exists for a unitary surface that is stable and easily traveled, as well as affordable. Further, a need exists for a surface with the grassy-like appearance and texture of natural turf. Finally, a need exists for a surface that minimizes other minor injuries, such as floor or turf burns, commonly associated with human recreation areas, such as playgrounds.

U.S. Pat. Nos. 5,958,527, 6,338,885, and 6,551,689 to Prevost illustrate one system for providing an artificial turf surface. Prevost teaches a synthetic grass surface having elongates ribbons of grass “blades”. Sand and rubber granules are in-filled around the grass blades in a mixture that is predominantly sand near the base of the blades and grades to exclusively rubber near the top of the blades. Prevost teaches that the synthetic grass surface preferably is placed on a soil substrate.

Prevost recognizes that sand is more abrasive than rubber particles and consequently rubber particles yield less wear on the blades of the synthetic turf. Prevost also recognizes that some resilience to the surface may be provided by the addition of the rubber particles. However, the multiply graded infill of Prevost may be difficult and costly to install. The use of multiple coating and depositing machines, as taught in the '885 patent, is mandated to achieve the desired ratios of sane to gravel. Also, Prevost specifically teaches away from the use of a uniform infill.

The synthetic grass surface of Prevost may be useful for a variety of purposes, but fails to provide many of the desired features for a playground surface. First, the rubber particles of Prevost may provide some impact dampening ability. However, because the rubber particles are positioned over and intermixed with sand, any such impact dampening ability is minimized and may even be less than soil.

Additionally, Prevost teaches a surface providing uniform impact dampening over area, and consequently does not teach providing areas of increased impact dampening. Areas of increased impact dampening may be especially useful in a playground setting near playground equipment, for example.

Consequently, a need exists for an artificial surface for human recreation areas such as playgrounds that may be easily and inexpensively installed. Also, especially in playground environments, a need exists for such a surface that may provide additional impact absorption near playground equipment, for example, where additional impact absorption may be desired to prevent injury.

### SUMMARY OF THE INVENTION

The preferred embodiments of the present invention provides an improved foundation or surface for a human recreation area such as a playground. An impact dampening layer preferably composed of an unbound impact dampening particulate is positioned on top of a foundation layer and under a cover layer. The depth of the impact dampening particulate may be increased to increase the impact dampening ability of the impact dampening layer. Additionally, the cover layer may be color coded by area to provide safety zones or to indicate regions of greater impact dampening.

### BRIEF DESCRIPTION OF THE DRAWINGS

FIG. 1 illustrates a vertical cut away view of a composite layered foundation for a human recreation area, such as a playground, which is formed of a plurality of layers, including an impact dampening layer, according to an embodiment of the present invention.

FIG. 2 illustrates a vertical cut away view of a first alternative composite layered foundation for a human recreation area, such as a playground, which is formed of a plurality of layers, including a support layer, according to an alternative embodiment of the present invention.

FIG. 3 illustrates a vertical cut away view of a second alternative composite layered foundation for a human recreation area, such as a playground, which is formed of a plurality of layers, including a drain mat upper drainage layer, according to an alternative embodiment of the present invention.

FIG. 4 illustrates an example of an impact dampening layer having variable thickness to provide additional impact absorption in a predetermined area.

FIG. 5 illustrates an exemplary configuration of the foundation of FIGS. 1-4 in conjunction with exemplary playground equipment in a playground environment.

FIG. 6 illustrates an alternative configuration of the foundation of FIGS. 1-4 in conjunction with exemplary playground equipment, an embedded game area, and an embedded graphic in a playground environment.

### DETAILED DESCRIPTION OF PREFERRED EMBODIMENTS

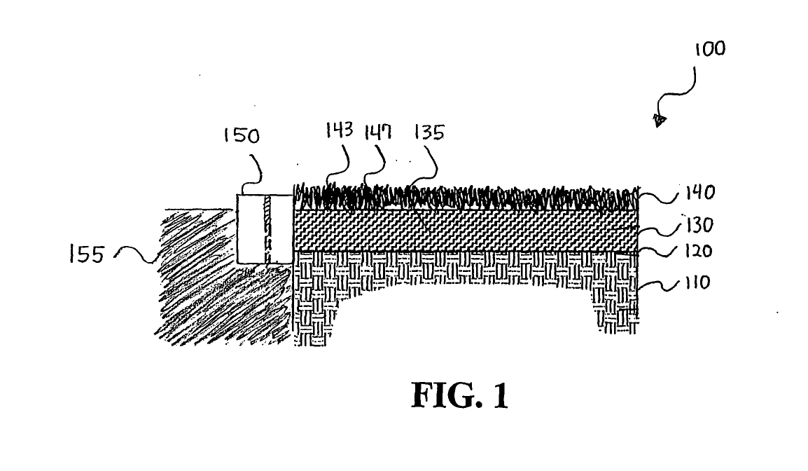

FIG. 1 illustrates a vertical cut away view of a composite layered foundation 100 for a human recreation area, such as a playground, which is formed of a plurality of layers, including an impact dampening layer 130, according to an embodiment of the present invention. The foundation 100 includes a foundation layer 110, a foundation drainage layer 120, an impact dampening layer 130, an impact dampening coarse particulate 135, a protective cover layer 140, a protective cover material 143, a fine particulate additive 147, a fixed barrier 150, and surrounding support material 155.

The foundation layer 110 is preferably established, located or positioned below the first drainage layer 120. The foundation drainage layer 120 preferably rests on and is vertically supported by the foundation layer 110. The impact dampening layer 130 preferably rests on and is vertically supported by the foundation drainage layer 120. The protective cover layer 140 preferably rests on and is vertically supported by the impact dampening layer 130.

The fine particulate additive 147 is preferably dispersed throughout the protective cover layer 140. The protective cover layer 140 is preferably water permeable and composed of a protective cover material such as artificial turf having grass-like protuberances or blades extending upwardly.

The fixed barrier 150 is preferably adjacent to and/or supported by the foundation layer 110 and helps to contain the rest of the foundation 100. The cover layer 140 may be affixed to the fixed barrier 150 to provide containment for the coarse particulate 135 of the impact dampening layer 130. The surrounding support material 155 is preferably adjacent to the fixed barrier 150 and the foundation layer 110.

The foundation layer 110 preferably includes compacted earth, concrete, stone, and/or asphalt, for example. The foundation layer 110 is preferably constructed and installed in accordance with known construction and installation techniques. For example, a specified area of earth may be excavated to an approximate depth. The remaining earth within the specified area may be compacted and leveled to a final depth, or a specified depth of concrete may be placed on top of the compacted earth. Alternatively, the foundation layer 110 may include existing earth, concrete, stone, and/or asphalt, for example. The depth of the foundation layer 110 is preferably a sufficient depth to provide a solid base or foundation for supporting the rest of the foundation 100. For example, a depth of 2 to 10 inches, depending on the supporting earth and surrounding surface, may typically be sufficient.

The foundation drainage layer 120 preferably includes a drainage system such as a geotextile fabric. The foundation drainage layer 120 is preferably constructed and installed in accordance with known construction and installation techniques. For example, a geotextile fabric may be rolled out on top of a specified area and cut to a specified length. Alternatively, a geotextile fabric may be pre-cut in sections of pre-determined size and placed on top of a specified area. The thickness of the foundation drainage layer 120 is preferably a sufficient thickness to separate the foundation layer 110 and the impact dampening layer 130, while allowing fluids, such as water, to pass freely through the rest of the foundation 100. For example, a thickness of 1/16 to 3/8 inches, depending on the size of the surface, amount of rainfall, and humidity, may typically be sufficient.

The impact dampening layer 130 is preferably at least in part constructed of the impact dampening coarse particulate 135. The coarse particulate 135 preferably includes rubber or thermoplastic elastomer. The coarse particulate 135 is preferably placed on top of the first drainage layer 120, although the foundation layer 110 preferably provides foundational support. Additionally, the positional stability of the coarse particulate 135 is greatly increased by the imposition of the protective cover layer 140 over the coarse particulate 135.

The depth of the coarse particulate 135 may vary over the foundation 100. For example, as further described below, the depth of the coarse particulate 135 may be greater near playground equipment or other areas in which additional impact dampening may be desired. The depth of the impact dampening layer 130 is preferably a sufficient depth to provide the desired impact dampening capability. For example, a depth of 2 to 6 inches away from equipment and 4 to 12 inches near equipment may typically be sufficient. Additionally, the shape of the impact dampening course particulate 135 is preferably rectangular, as opposed to square or round. The rectangular shape may assist in minimizing the movement of the individual particles of course particulate 135 within the impact dampening layer 130.

The impact dampening ability of the coarse particulate 135 may also be referred to as the impact minimizing, reducing, or resistance of the surface. Although the impact dampening layer 130 is preferably composed exclusively of rubber particles, the impact dampening layer 130 may include substances other than rubber particles in addition to the rubber particles. For example, rubber particles mixed with an alternative impact dampening material such as organic material like wood chips may be employed.

Additionally, the coarse particulate 135 in the impact dampening layer 130 is preferably unbound. That is, the individual pieces of the coarse particulate are preferably not structurally bonded to one another. In this sense, the impact dampening layer 130 is preferably composed of unbound or free to move particulate.

The protective cover layer 140 is preferably, at least in part, constructed of the protective cover material 143 and the fine particulate additive 147. The protective cover material 143 preferably includes a material with a grass-like appearance having the color and appearance of mowed grass. For example, artificial turf or Edel Grass may be employed. The protective cover material 143 is preferably placed on top of the impact dampening layer 130. For example, artificial turf may be rolled out on top of a specified area and cut to a specified length. Alternatively, artificial turf may be pre-cut in sections of pre-determined size and placed on top of a specified area. In addition, the protective cover material 143 is preferably fastened to the fixed barrier 150. For example, artificial turf may be stretched to the edge of landscape timber edging and held in place with a tacking strip, nails, or other similar techniques. The thickness of the protective cover material 143 is preferably a sufficient thickness to contain the impact dampening coarse particulate 135 and to provide a grass-like appearance having the color and appearance of mowed grass. For example, a thickness of 1 to 2 inches, depending on the type of material selected, may typically be sufficient.

The fine particulate additive 147 preferably includes rubber or thermoplastic elastomer. The fine particulate additive 147 is preferably dispersed throughout the protective cover material 143. For example, fine particulate rubber may be placed on top of artificial turf in bulk and spread to a specified depth. Alternatively, fine particulate rubber may be scattered over artificial turf until a specified depth has accumulated. The depth of the fine particulate additive 147 is preferably a sufficient depth to enhance the grassy-like appearance and texture of the protective cover material 143. For example, a depth of 1 to 2 inches may typically be sufficient. Depending upon the structure of the cover material 143, a depth of 1 to 2 inches may correspond to approximately 3 lbs. per square foot of cover material. However, the depth of the fine particulate additive 147 preferably should not exceed the thickness of the protective cover material 143. For example, the height of the protective cover layer 143 is preferably at least 1/2 inch taller than the depth of the fine particulate additive 147.

The fixed barrier 150 preferably includes a stationary material such as landscape timber edging, plastic edging, or concrete. The fixed barrier 150 is preferably adjacent to the foundation layer 110 and fixedly attached to the surrounding earth. For example, landscape timber edging may be placed around the perimeter of a specified area and staked into the earth at specified locations. In addition, the fixed barrier 150 is preferably attached to the foundation layer 110 and the protective cover layer 140 to help contain the impact dampening coarse particulate 135. For example, landscape timber edging may be fastened to a concrete foundation with pre-installed hooks or clips. Alternatively, the fixed barrier 150 may be installed when the foundation layer 110 is installed and may be formed as part of the foundation layer 110.

The surrounding material 155 may be an extension of the foundation layer 110, or may be composed of compacted earth or other materials that enable the fixed barrier 150 to be fixedly positioned.

The increases in the impact dampening capability of the composite layered foundation 100 are preferably determined by the depth of the impact dampening coarse particulate 135 and, to a lesser extent, by the depth of the fine particulate additive 147. The depth of the impact dampening coarse particulate 135, typically depends on the requirements of the human recreation area. For example, additional impact dampening capability may be desirable for playgrounds with elevated structures. The additional impact dampening capability may be desirable because of the increased fall distance associated with elevated structures. Consequently, to provide the desired impact dampening capability, the depth of the impact dampening coarse particulate 135 may be increased.

Alternatively, the foundation layer 110 preferably may provide the foundation 100 with additional impact dampening capability. For example, if the foundation layer is composed of sand or gravel, the sand and/or gravel may provide additional impact dampening. The additional impact dampening provided by the sand and/or gravel may be above and beyond that provided by the impact dampening layer 130, the impact dampening course particulate 135, and the fine particulate additive 147, thereby providing a built-in safety factor or redundancy within the foundation 100.

Additionally, the enhanced drainage provided by the impact dampening coarse particulate assists in maintaining the position and appearance of the foundation 100. For example, rubber particles typically float in water. Consequently, adequate drainage from the foundation 100 is desirable to prevent damage to the foundation 100. That is, the coarse particulate 135 preferably allows fluids, such as water, to freely drain from the foundation 100. Consequently, rubber particles such as the coarse particulate 135 and the fine particulate 147 are preferably not disturbed by the water received by the foundation 100, for example, during a rain storm or while cleaning the foundation 100. Consequently, the enhanced drainage characteristics provided by the coarse particulate 135 preferably prevent, or at least minimize, the erosion of the fine particulate additive 147.

The requirements for a human recreation area are preferably determined in accordance with predetermined safety standards. Additionally, the depth of the impact dampening coarse particulate 135 is preferably variable within the composite layered foundation 100, depending on the requirements of the human recreation area. For example, a 10-foot slide may require more impact dampening capability than a 2-foot elevated platform. Greater impact dampening capability may be desirable because of the increased fall distance from the a 10-foot slide, as compared to a 2-foot platform. Consequently, the depth of the coarse particulate 135, and therefore, the impact dampening capability of the unbound composite layered foundation 100, may be greater near a 10-foot slide than a 2-foot platform. The requirements for a human recreation area, such as a playground, are preferably determined prior to the installation of the composite layered foundation 100.

The sequence of steps to install the foundation 100 preferably proceeds as follows. As will be appreciated by those of skill, certain steps may be performed in ways other than those recited below and the steps may be performed in sequences other than that recited below. First, the foundation layer 110 is preferably installed, followed by the fixed barrier 150. Additionally, the fixed barrier 150 is preferably attached to the foundation layer 110 to enclose the rest of the foundation 100 and, in particular, to help to contain the impact dampening coarse particulate 135. Next, the foundation drainage layer 120 is preferably installed above the foundation layer 110. The impact dampening layer 130 is preferably installed above the first drainage layer 120, although the foundation layer 110 preferably provides most of the support for the impact dampening layer 130 and the rest of the foundation 100. Finally, the protective cover layer is preferably installed above the impact dampening layer 130 and the fine particulate additive 147 is preferably dispersed throughout the protective cover material 143. The protective cover material 143 and the fine particulate additive 147 preferably provide the appearance and texture of natural turf. In addition, the protective cover layer 140 is preferably attached to the fixed barrier 150, preferably containing and protecting the impact dampening coarse particulate 135. Consequently, the composite layered foundation 100 is preferably low maintenance compared to other loose-fill materials, and preferably less expensive and easier to install than unitary materials.

In operation, the composite layered foundation 100 preferably functions to dampen, minimize or reduce the impact of a fall at a human recreation area, such as a playground, thereby, as discussed in the background above, minimizing the seriousness of the resulting injury. As a person falls on the foundation 100, the initial impact preferably encounters the protective cover layer 140. The elements of the protective cover layer 140, in particular, the protective cover material 143 and the fine particulate additive 147, preferably dampen at least a portion of the impact. However, most of the impact is typically propagated through the protective cover layer 140 and into the impact dampening layer 130, in particular, the impact dampening coarse particulate 135. The impact dampening layer 130 preferably functions to dampen the impact of a fall, for example through vertical and/or lateral displacement and/or compression of the impact dampening course particulate 135. The displacement or compression of the impact dampening course particulate 135 within the impact dampening layer 130 is preferably a sufficient displacement or compression to dampen the impact of a fall. The displacement of the impact dampening layer 130 in response to an impact on the foundation 100 varies in response to the force applied to the foundation 100. For example, a fall from a higher distance or a more weighty person causes a proportional increase in the displacement of the impact dampening layer 130.

The protective cover layer 140 preferably contains the layers of the composite layered foundation 100. The protective cover layer 140 preferably assists in maintaining a uniform depth of the impact dampening coarse particulate 135 in the impact dampening layer 130, thereby preserving the impact dampening capability of the unbound composite layered foundation 100. For example, once the protective cover layer 140 has been installed, users are much less able to displace the impact dampening coarse particulate. That is, the protective cover layer 140 prevents users of the foundation 100 from having access to the impact dampening coarse particulate 135. Consequently, users are less able to displace the coarse particulate 135 through falls or purposeful movement, for example.

Additionally, installing the protective cover layer 140 provides a convenient running and walking surface for users. User motion over the foundation 100 is typically consequently much easier and more enjoyable than through shredder rubber tires, for example. That is, the protective cover layer 140 preferably provides a stable and unitary surface on which to move.

Further, the protective cover layer 140 preferably protects the impact dampening layer 130 from potentially damaging environmental effects. The protective cover layer 140, in particular, the protective cover material 143 and the fine particulate additive 147, preferably provides the look and feel of a natural, grassy-like surface. The fixed barrier 150 preferably contains the layers of the composite layer foundation 100.

Additionally, the protective cover layer 140, including the protective cover material 143 and the fine particulate additive 147, preferably minimizes other minor injuries, such as floor or turf burns, commonly associated with human recreation areas, such as playgrounds.

Once the foundation 100 has been installed, the foundation drainage layer 120 preferably operates as a drainage system for the composite layered foundation 100. That is, the foundation drainage layer 120 preferably allows fluids, such as water, to pass freely through the unbound composite layered foundation 100. Consequently, the foundation 100 preferably has good drainage and may be easily cleaned.

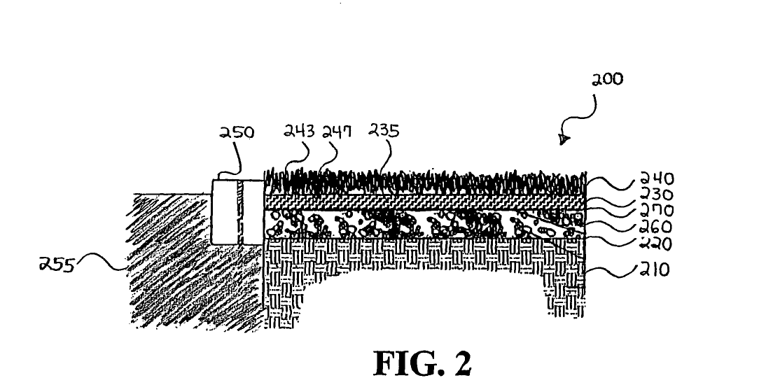

FIG. 2 illustrates a vertical cut away view of a first alternative composite layered foundation 200 for a human recreation area, such as a playground, which is formed of a plurality of layers, including a support layer 260, according to an alternative embodiment of the present invention. The first alternative composite layered foundation 200 is similar to the composite layered foundation 100 of FIG. 1 and includes all of the elements of the foundation 100 of FIG. 1, but additionally includes a support layer 260 and a second drainage layer 270.

That is, the foundation 200 includes a foundation layer 210, a foundation drainage layer 220, a support layer 260, an upper drainage layer 270, an impact dampening layer 230, an impact dampening coarse particulate 235, a protective cover layer 240, a protective cover material 243, a fine particulate additive 247, a fixed barrier 250, and surrounding support material 255.

The foundation layer 210, foundation drainage layer 220, impact dampening layer 230, impact dampening coarse particulate 235, protective cover layer 240, protective cover material 243, fine particulate additive 247, fixed barrier 250, and surrounding support surface 255 are similar to their respective layers in FIG. 1 and are described above.

The support layer 260 is added on top of the foundation drainage layer 220 and underneath the upper drainage layer 270. The upper drainage layer 270 is added on top of the support layer 260 and underneath the impact dampening layer 230.

The support layer 260 is preferably constructed of a support material such as crushed stone, sand, pea gravel, recycled asphalt, or concrete, for example. The support layer 260 is preferably constructed and installed in accordance with known construction and installation techniques. For example, crushed stone or gravel may be placed on top of a specified area in bulk and spread to a specified depth. Alternatively, crushed stone or gravel may be scattered over a specified area until a specified depth has accumulated. The support layer 260 preferably provides additional stability and load bearing capacity to the unbound composite layered foundation 200. Additionally, the support layer 260 preferably provides enhanced drainage capability. The depth of the support layer 260 is preferably a sufficient depth to provide enhanced support and drainage to rest of the foundation 200. For example, a depth of 2 to 10 inches, depending on the supporting earth and surrounding surface, may typically be sufficient.

The upper drainage layer 270 is generally similar to the first drainage layer 220. The construction and operation of the upper drainage layer 270 and the foundation drainage layer 220 are similar to that of the foundation drainage layer 120 of FIG. 1. That is, the upper drainage layer 270, as discussed above, preferably allows fluids, such as water, to freely drain from the foundation 200 and preferably includes 1/16 to 3/8 inches of geotextile fabric.

In the embodiment of FIG. 2, the second drainage layer 270 also serves to separate the support layer 260 and the impact dampening layer 230. Because both the support layer 260 and underneath the impact dampening layer 230 are composed of particulate, the upper drainage layer 270 is preferably chosen to minimize intermixing of the particulates of the support layer 260 and the impact dampening layer 230.

In operation, the addition of the support layer 260 and the upper drainage layer 270 to the foundation 200 as compared to the foundation 100 of FIG. 1 provides the additional benefits of enhanced drainage and greater ease of sculpting of the foundation 200. For example, the support layer 260 may be considerably easier to grade or more cost effective to install than a concrete foundational level. The addition of the support layer 260 may also be especially useful when the foundation layer 210 is composed of earth or other non-unitary material. When the foundation layer 210 is composed of earth, the crushed gravel of the support layer 260 serves to provide increased additional stability and load-bearing capacity, as well as enhanced drainage for the foundation 200.

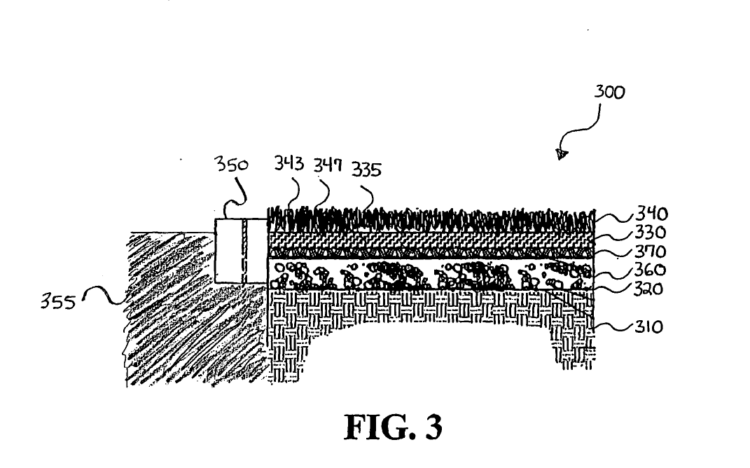

FIG. 3 illustrates a vertical cut away view of a second alternative composite layered foundation 300 for a human recreation area, such as a playground, which is formed of a plurality of layers, including a drain mat upper drainage layer 370, according to an alternative embodiment of the present invention. The second alternative composite layered foundation 300 is similar to the composite layered foundation 200 of FIG. 2 but changes the rendition of the upper drainage system 370 from a geotextile fabric to a drain mat. That is, the second alternative composite layered surface includes all of the elements of the surface of FIG. 2, but substitutes a drain mat for the geotextile fabric of the upper drainage system 270 of FIG. 2.

That is, the foundation 300 includes a foundation layer 310, a foundation drainage layer 320, the support layer 360, an impact dampening layer 330, an impact dampening coarse particulate 335, a protective cover layer 340, a protective cover material 343, a fine particulate additive 347, a fixed barrier 350, and a surrounding support material 355, all of which are described with reference to FIG. 2, above. The foundation 300 also includes an upper drainage layer 370, but in the foundation 300, the upper drainage layer 370 is a drain mat rather than the geotextile fabric of the upper drainage layer 270 of FIG. 2.

Comparing the drain mat to the geotextile fabric, the drain mat preferably also provides for drainage of liquids. However, the drain mat may be somewhat greater in thickness than the geotextile fabric. Additionally, the drain mat may also provide for increased drainage relative to the geotextile fabric.

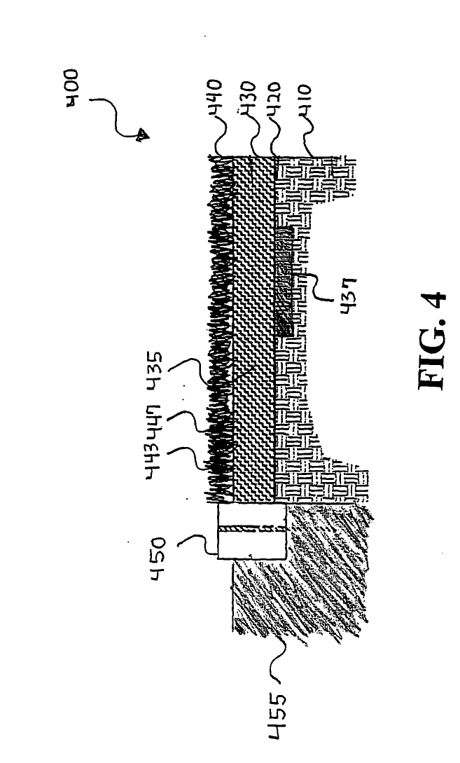

FIG. 4 illustrates an example of an impact dampening layer 430 having variable thickness to provide additional impact absorption in a predetermined area. As discussed above, the thickness of the impact dampening layer may vary as desired in order to provide a greater level of impact dampening in desired areas. The difference in the thickness of the impact dampening layer 430 shown in FIG. 4 is varied as desired to provide additional impact dampening and is for illustrative purposes and not necessarily to scale.

The foundation 400 of FIG. 4 is similar to the foundation 100 of FIG. 1 and includes all of the elements of the foundation 100 of FIG. 1. That is, the foundation 400 includes a foundation layer 410, a foundation drainage layer 420, an impact dampening layer 430, an impact dampening course particulate 435, a protective cover layer 440, a protective cover material 443, a fine particulate additive 447, a fixed barrier 450, and a surrounding support material 455, all of which are described above with reference to FIG. 1.

Additionally, the foundation 400 also includes an increased-depth impact dampening region 437 within the impact dampening layer 430. The increased-depth impact dampening area may provide increased impact dampening in a desired area of the foundation 100.

To construct the increased depth impact dampening region 437, an indentation or depression is preferably made in the top surface of the foundation layer 410. Impact dampening coarse particulate 435 is then placed in the depression in order to form the increased depth impact dampening region 437. Additional amounts of impact dampening coarse particulate 435 are placed on top of the foundation layer 100 and on top of the increased depth impact dampening region 437 until a predetermined, desired depth of impact dampening coarse particulate 435 has been established. The impact dampening coarse particulate 435 is then graded flat and the protective cover layer 440 is positioned on top of the impact dampening coarse particulate 435.

In operation, the increased depth impact dampening region 437 serves to provide additional impact dampening in a desired region of the foundation 400. The additional impact dampening arises due to the increased depth of the impact dampening coarse particulate 435 in the increased depth impact dampening region 437. Additionally, although FIG. 4 illustrates a single increased depth impact dampening region 437, multiple similar regions may be employed in a single foundations.

Additionally, the depth of the increased depth impact dampening region 437 may vary depending upon the desired impact dampening. For example, the depth of the increased depth impact dampening region 437 may be increased near a slide or other vertical structure elevated from said foundation in order to provide increased impact dampening in case a user falls from the structure. Alternatively, any desired depth may be provided for the increased depth impact dampening region 437 or for the impact dampening layer 430.

Additionally, the depth of the increased depth impact dampening region 437 may vary across the increased depth impact dampening region 437. For example, the increased depth impact dampening region 437 need not be a square notch as exemplarily illustrated in FIG. 4. Instead the side walls of the increased depth impact dampening region 437 may angle downwardly into the foundation layer 410 in a variety of ways. The increased depth impact dampening region 437 also need not be symmetric. That is, one end of the increased depth impact dampening region 437 may be deeper than the other.

The increased depth impact dampening region 437 may also be of any shape and size parallel to the foundation 100. The increased depth impact dampening region 437 is not limited to any specific geometric shape and may be configured as desired.

Alternatively, instead of creating an indentation or depression in the top surface of the foundation layer 410 in order to create the increased depth impact dampening region 437, the top surface of the foundation layer 410 may remain flat and additional amounts of impact dampening coarse particulate may be positioned in the areas in which increased impact dampening is desired. Although the resulting increased depth impact dampening region 437 would be a raised mound instead of a flat and level surface, the total depth of the impact dampening coarse particulate, and consequently the total impact dampening in a given area, would be increased.

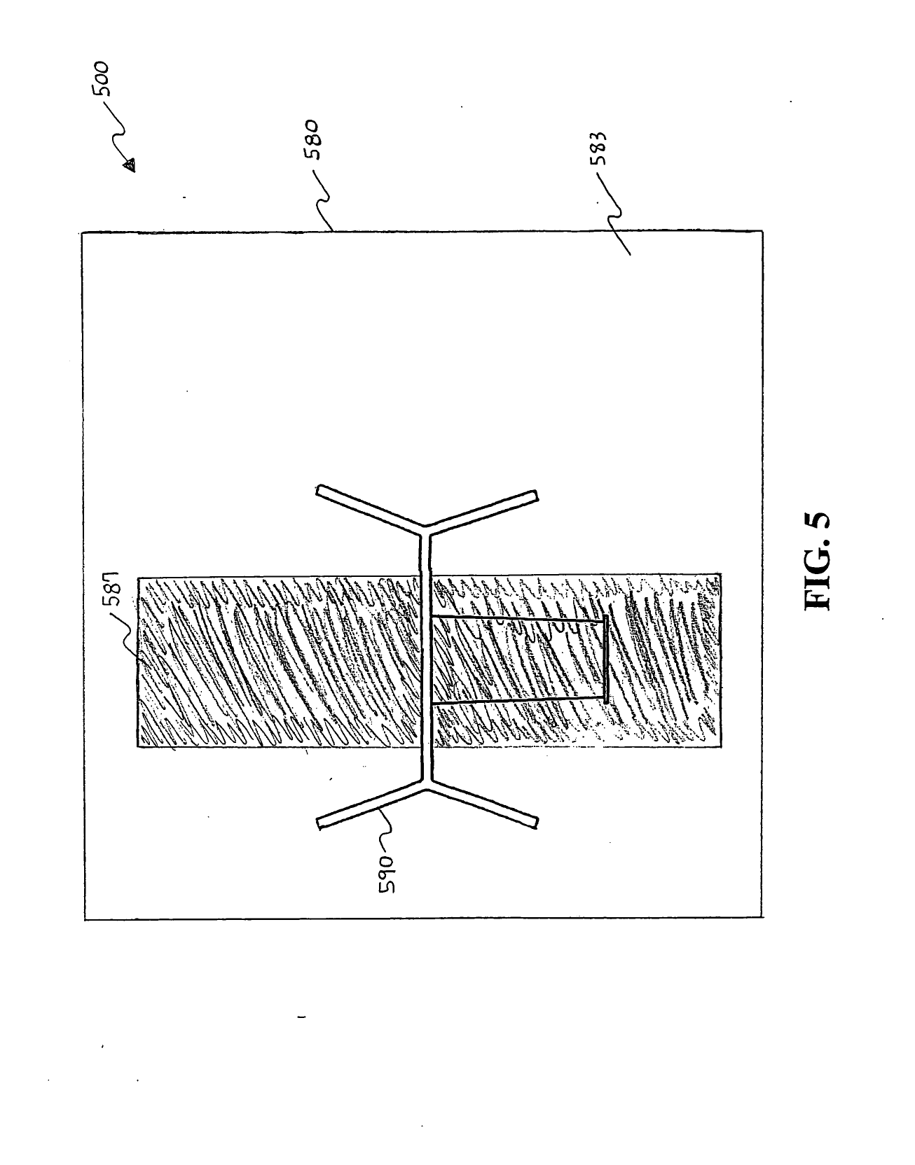

FIG. 5 illustrates an exemplary configuration 500 of the foundation of FIGS. 1-4 in conjunction with exemplary playground equipment 590 in a playground environment. As shown in FIG. 5, the configuration 500 includes a top or visible surface 580 of the foundation, a first color coded region 583, a second color coded region 587, and playground equipment 590.

The top or visible surface 580 is preferably composed of the cover layer of the foundation as illustrated with reference to FIGS. 1-4. The surface 580 is shown as being color coded to correspond to the impact dampening level of a particular region. That is, the first color coded region 583 preferably corresponds to a first depth of impact dampening course particulate and the second color coded region 587 corresponds to a second, preferably increased, depth of impact dampening coarse particulate.

Consequently, in the second color coded region 587, additional impact dampening is available due to the additional thickness of the impact dampening layer in the second color coded region. This design helps to increase safety in two ways. First, additional impact dampening is provided near playground equipment where additional impact dampening is desired. For example, additional impact dampening may be desired in case users of the swings exit the swings in an unorthodox manner such as by jumping or falling off the swings. Additionally, an increased depth area may be provided near any equipment that rises vertically from the surface of the foundation to provide additional impact dampening to users who were unsuccessfully attempting to climb the equipment.

Second, by color coding the areas of increased impact dampening, users of the playground equipment may conform their activities to areas providing appropriate levels of impact dampening. For example, if users of playground equipment do choose to use the equipment in unintended ways, such as by jumping off the equipment, the users are provided with a consistent, forgiving amount of impact dampening so as to reduce injury.

The first and second color coded regions 583, 587 may be coded with any of a variety of colors. Alternatively, the regions may be coded using texturing of the cover layer, such as varying the “grass” height of the artificial turf of the cover layer or varying the prevailing density of the “grass” of the artificial turf of the cover layer. Alternatively, any user-recognizable differentiation between the first and second color coded regions 583, 587 may be employed.

Additionally, more than two color coded regions may be included in a single playground area. For example, each piece of playground equipment may be surrounded by its own color coded areas. Additionally, color coded areas corresponding to three or more depths of impact dampening coarse particulate may be used. Alternatively, different color coded areas may not correspond to differing depths of impact dampening coarse particulate. For example, an area having the typical depth of impact dampening coarse particulate may be coded a first color while any area having any other depth may be coded any of a variety of colors.

The size of the color coded regions may be any size desired. Additionally, the impact dampening provided in a single color coded region may be graded or otherwise not consistent as discussed above. For example, the impact dampening level of a region under a swing might be graded to be deeper in front an shallower in back considering that swing users typically do not jump off backwards.

Alternatively, regions may be color coded for safety purposes without adding additional impact absorption. For example, a region may be represented by an area on the foundation corresponding to a radius of clearance from the path of a swinging swing. Users may preferably be encouraged to stand outside of such a “risk zone” or “safety zone” when the swing is in use.

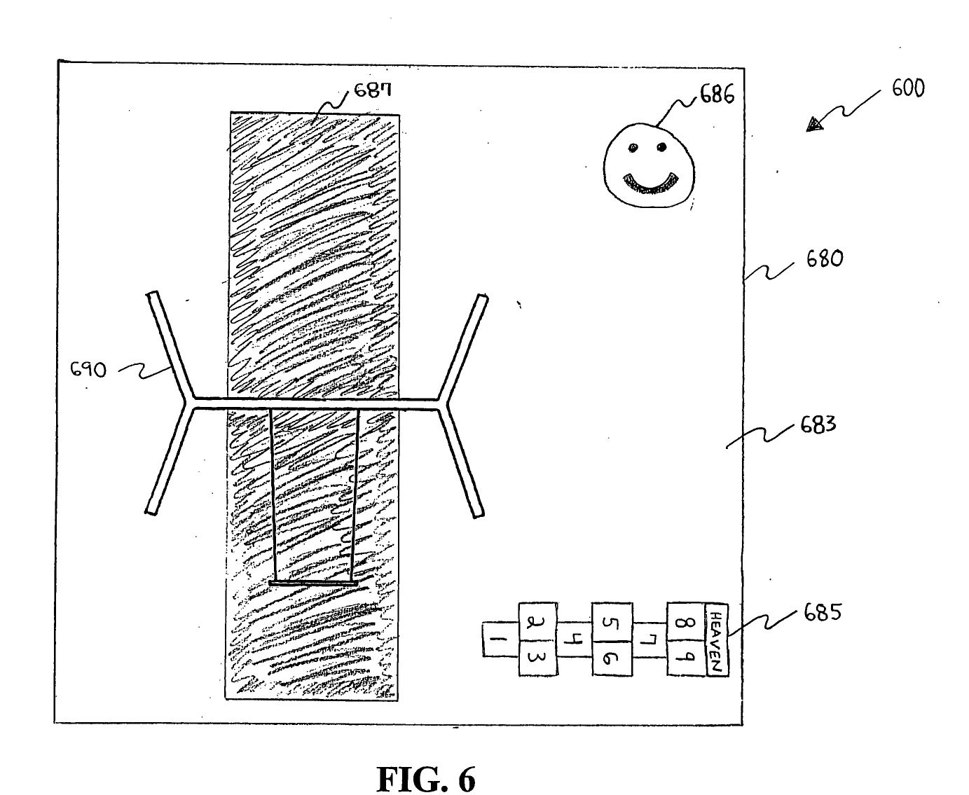

FIG. 6 illustrates an alternative configuration 600 of the foundation of FIGS. 1-4 in conjunction with exemplary playground equipment 690, an embedded game area 685, and an embedded graphic 686 in a playground environment. As shown in FIG. 6, the configuration 600 includes a top or visible surface 680 of the foundation, a first color coded region 683, a second color coded region 687, playground equipment 690. Other additions to the foundation 600 of FIG. 6 are the embedded game area 685, and the embedded graphic 686.

The embedded game area 685 is preferably composed by color coding the top surface 680 in such a way as to produce a game surface. For example, as shown in FIG. 6, the game area 685 represents a hop-scotch type game, a common child's game involving jumping from one square to another. Each of the squares may be represented by having the artificial turf of the top surface 680 be a different color in the region of the square. Preferably, the artificial turf is not merely colored on the exterior portion, but the color of the turf extends down to the binding mat and into the interior of the artificial turf. By coloring the actual turf of the top surface 680, the resultant game area 685 is highly wear resistant and still benefits from the impact-absorption of the underlying foundation layer.

Additionally, as mentioned above, the foundation 600 may include an embedded graphic 686. The embedded graphic 686 may be any of a variety of cartoon or whimsical characters, or may represent a school's mascot, for example. The embedded graphic 686 is preferably constructed by coloring the turf or other outer layer of the top surface 680, as described above with reference to the game area 685. The embedded graphic 686 may be useful, for example, as a pre-selected meeting area for users of the playground and/or their parents or guardians. Additionally, the placement of the embedded graphic 686 may assist in directing user flow throughout the playground. For example, an embedded graphic 686 may be placed as a starting point for a line to form to use a particular piece of playground equipment. Alternatively, a series of embedded graphic 686 may be positioned as a trail to direct users through the playground.

Neither the embedded graphic 686 nor the game area 685 need necessarily have greater impact dampening properties, but additional impact dampening may be provided if desired. Additionally, neither the embedded graphic 686 nor the game area 685 need necessarily be composed of different colors; any user-recognizable configuration may be employed, such as altering the height of the “grass” of the artificial turf of the top surface 680.

Thus, the embodiments of the invention provide an improved foundation or surface for human recreation areas such as playgrounds. Also, the improved surface provides increased reliability and uniformity of impact dampening properties. That is, because the cover layer acts to constrain the movement of the particulate in the particulate layer, the level of particulate in the particulate layer remains more constant than as compared to pits of shredded rubber tires. Additionally, the present surface is much easier for people to more around on than shredded tires because a firm, though yielding surface is provided. Also, the present surface is typically much less expensive than other unitary surfaces, such as a poured rubber surface, for example. Finally, the present surface preferably provides the look and feel of grass due to the inclusion of the rubber particulate in the artificial turf. The rubber particulate feels to a user like soil and makes the artificial turf appear more natural.

Additionally, because the cover layer provides a firm surface suitable for many modes of transportation, including wheelchair transportation, the present foundation provides a vastly preferable playground surface to prior art playground surfaces involving loose-fill. For example, a wheelchair would be unable to negotiate a playground surface composed of wood chips, for example, but may be able to easily negotiate the surface of the present foundation. Consequently, the present foundation would be much more likely to comply with legislation such as the ADA, as well as the safety guidelines established by the CPSC.

Furthermore, although not shown in the drawings, the foundation may preferably include additional drainage systems, such as drain pipe or french drains. As previously discussed, rubber particles may float in water. Consequently, additional drainage may be desirable to allow fluids, such as water, to drain freely from the foundation rather than build-up and disturb the rubber particles.

Additionally, as mentioned above, the foundation includes two layers of rubber particles, a fine particulate additive interspersed in the artificial turf and a coarse particulate layer. As mentioned above, the coarse particulate layer serves to provide the majority of the impact dampening provided by the foundation. However, the fine particulate may provide some additional impact dampening.

As mentioned in the background above, no prior art surfaces have included an impact dampening coarse particulate layer under a turf-like layer. However, some prior art systems have included a turf like layer with fine rubber particles interspersed in the turf-like layer. In the prior art, all of the impact dampening is provided by these fine rubber particles.

However, fine rubber particles are typically at least twice as expensive as coarse rubber particles by weight. Consequently, such prior art systems are typically much more expensive then the present system when providing an equivalent amount of impact dampening.

It will be readily appreciated by those of skill in the art that the total impact dampening desired to be provided by a surface may be proportioned between the fine particulate layer an the coarse particulate layer. However, because the coarse particulate is considerably less expensive then the fine particulate, the amount of fine particulate employed is preferably minimized.

However, typically users of the surface still desire a certain height (such as one half inch, for example) of turf to extend upward from the fine rubber particulate. Conversely, employing less fine rubber particulate may lead to an increased turf height extending upward from the fine rubber particulate. Consequently, in order to maintain the desired turf height while minimizing the amount of fine rubber particulate employed, a specialized artificial surface with a specially predetermined turf height may be employed. That is, the height of the turf of the artificial surface may be matched to the depth of the fine rubber particulate to be employed plus the user-desired height of turf extending upward from the fine rubber particulate. Consequently, the user still enjoys the desired turf height while the amount of fine rubber particulate is reduced.

While particular elements, embodiments and applications of the present invention have been shown and described, it will be understood that the invention is not limited thereto since modifications may be made by those skilled in the art, particularly in light of the foregoing teachings. It is therefore contemplated by the appended claims to cover such modifications as incorporate those features which come within the spirit and scope of the invention.

1. A layered foundation for a human recreation area, said foundation including:
an unbound particulate layer; and
a protective cover layer positioned over said particulate layer.

2. The foundation of claim 1 wherein said particulate layer includes, at least in part, coarse rubber particulate.

3. The foundation of claim 1 wherein the depth of said particulate layer is adjusted to achieve a desired impact resistance.

4. The foundation of claim 1 wherein said cover layer includes, at least in part, artificial turf.

5. The foundation of claim 4 wherein said cover layer includes a fine particulate dispersed into said artificial turf.

6. The foundation of claim 5 wherein said fine particulate is rubber.

7. The foundation of claim 5 wherein said fine particulate is dispersed into said artificial turf to simulate the appearance of natural turf.

8. The foundation of claim 5 wherein said fine particulate is dispersed into said artificial turf to simulate the texture of natural turf.

9. The foundation of claim 5 wherein said fine particulate is dispersed into said artificial turf to add additional impact resistance to the impact resistance provided by the particulate layer.

10. The foundation of claim 1 wherein said foundation includes a drainage layer positioned below said particulate layer.

11. The foundation of claim 10 wherein said drainage layer enhances fluid flow from said foundation to the surrounding earth.

12. A composite layered foundation, said foundation including:
a coarse particulate layer;
a protective cover layer positioned over said coarse particulate layer; and
a fixed barrier contacting said coarse particulate layer to assist in containing said coarse particulate layer.

13. The foundation of claim 12 wherein said particulate layer includes, at least in part, coarse rubber particulate.

14. The foundation of claim 12 wherein the depth of said particulate layer is adjusted to achieve a desired impact resistance.

15. The foundation of claim 12 wherein said cover layer includes, at least in part, artificial turf.

16. The foundation of claim 15 wherein said cover layer includes a fine particulate dispersed into said artificial turf.

17. The foundation of claim 16 wherein said fine particulate is rubber.

18. The foundation of claim 16 wherein said fine particulate is dispersed into said artificial turf to simulate the appearance of natural turf.

19. The foundation of claim 16 wherein said fine particulate is dispersed into said artificial turf to simulate the texture of natural turf.

20. The foundation of claim 16 wherein said fine particulate is dispersed into said artificial turf to add additional impact resistance to the impact resistance provided by the particulate layer.

21. The foundation of claim 12 wherein said foundation includes a drainage layer positioned below said particulate layer.

22. The foundation of claim 21 wherein said drainage layer enhances fluid flow from said foundation to the surrounding earth.

23. The foundation of claim 12 wherein said fixed barrier is attached to said cover layer.

24. A recreational area for human recreation, said recreational area including:
a composite foundation, said composite foundation including:
a coarse particulate layer;
a protective cover layer positioned over said coarse particulate layer; and
a fixed barrier contacting said coarse particulate layer to assist in containing said coarse particulate layer; and
at least one structure, wherein said at least one structure may be used by a user to elevate the user from the foundation of the recreational area.

25. The foundation of claim 24 wherein said particulate layer includes, at least in part, coarse rubber particulate.

26. The foundation of claim 24 wherein the depth of said particulate layer is adjusted to achieve a desired impact resistance.

27. The foundation of claim 24 wherein the depth of said particulate layer is increased near said at least one structure to provide additional impact resistance.

28. The foundation of claim 24 wherein said cover layer includes, at least in part, artificial turf.

29. The foundation of claim 28 wherein said cover layer includes a fine particulate dispersed into said artificial turf.

30. The foundation of claim 29 wherein said fine particulate is rubber.

31. The foundation of claim 29 wherein said fine particulate is dispersed into said artificial turf to simulate the appearance of natural turf.

32. The foundation of claim 29 wherein said fine particulate is dispersed into said artificial turf to simulate the texture of natural turf.

33. The foundation of claim 29 wherein said fine particulate is dispersed into said artificial turf to add additional impact resistance to the impact resistance provided by the particulate layer.

34. The foundation of claim 24 wherein said foundation includes a drainage layer positioned below said particulate layer.

35. The foundation of claim 34 wherein said drainage layer enhances fluid flow from said foundation to the surrounding earth.

36. The foundation of claim 24 wherein said fixed barrier is attached to said cover layer.

37. A foundation for use in a human recreation area, said foundation including:
a first location providing a first level of impact dampening;
a second location providing a second level of impact dampening; and
a cover layer covering said first location and said second location, wherein said cover layer provides an indication of the position of said first location and said second location.
